(19) United States
(12) Patent Application Publication
(10) Pub. No.: US 2004/0160431 A1
(43) Pub. Date: Aug. 19, 2004

(54) Pointer with non-scratch tip

(76) Inventors: James DiMambro, Chicago, IL (US); Tom DiMambro, Troy, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/773,741

(22) Filed: Feb. 6, 2004

Related U.S. Application Data
(60) Provisional application No. 60/445,961, filed on Feb. 7, 2003.

(51) Int. Cl. G09G 5/00

(52) U.S. Cl. 345/179

(57) ABSTRACT

A pointer assembly for identifying locations on a monitor includes an expandable member having a distal end. The distal end is enclosed by a tip having a durometer hardness selected to prevent scratching and marring of the monitor.

### RELATED APPLICATIONS

The present patent application claims priority to all the benefits of U.S. patent application Ser. No. 60/445,961, filed Feb. 7, 2003.

### FIELD OF THE INVENTION

The present invention relates generally toward a mechanical pointer for identifying locations on a monitor. More specifically, the present invention relates toward a mechanical pointer adapted to contact a monitor in a non-damaging manner.

### BACKGROUND OF THE INVENTION

With the advent of computer technology in the workplace, paper products are being used less frequently for both industrial design and presentations. Generally, consumer products and industrial devices are manufactured with the assistance of computer aided design where mathematical data identifying dimensional configuration of these products has entirely replaced designs both produced and presented on paper products. Additionally, large monitors are now used for presentations in conference rooms and offices rather than preparing paper presentation aids.

Computer monitors have been steadily evolving into high tech, liquid plasma or LCD and equivalent monitor technology to reduce the space required of older generation monitors and to increase the quality of the image being generated. These high tech monitors are prone to marring, scratching and smearing when pencils, pens, and fingers are used to identify specific pixels or areas of the image displayed on the monitor. Minimally, these high tech monitors require frequent cleaning when marred or smeared, and in a worse case scenario, replacement when the monitor screen has been scratched or otherwise damaged by use of an inappropriate pointer.

Presently, pointers used with these types of monitors have not been adapted to prevent scratching, marring, or smearing. Therefore, it would be desirable to provide a pointer that has been adapted for use with these types of monitors that will not cause the damage that is readily apparent by present methods of identifying particular pixels or areas represented on the monitor.

### SUMMARY OF THE INVENTION

A pointer assembly for identifying locations on a plasma or other computer monitor includes an expandable member with a distal end. The distal end is enclosed by a tip having a durometer hardness selected to prevent scratching and marring of the monitor.

The pointer assembly of the present invention provides both an expandable member for ease of access to a computer screen and also, more preferably, a tip with a predetermined durometer hardness that allows the pointer assembly to contact a monitor screen such as, for example, a liquid plasma or LCD or and equivalent high tech monitor screen without causing scratching or marring presently caused by pencils, pens, erasers, or fingers. The appropriate material selection having a desirable durometer hardness has solved the problems associated with identifying specific pixels or locations on a monitor during presentations displaying the electronic images generated by computers or video.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of the inventive pointer assembly;

FIG. 2 is an environmental view of the inventive pointer assembly;

FIG. 3 is an environmental view of an alternate embodiment of the inventive pointer assembly showing an associated retention clip;

FIG. 4 is a further environmental view of the inventive pointer assembly;

FIG. 5 is a sectional view of the tip associated with the inventive pointer assembly;

FIG. 6 is a sectional view of an alternate embodiment of the tip;

FIG. 7 is a further alternate embodiment of the inventive tip;

FIG. 8 is a sectional view of a still further embodiment of the inventive tip showing a coating; and

FIG. 9 is a still further embodiment of the inventive tip showing a human appendage.

### DETAILED DESCRIPTION OF THE PREFERRED EMBODIMENT

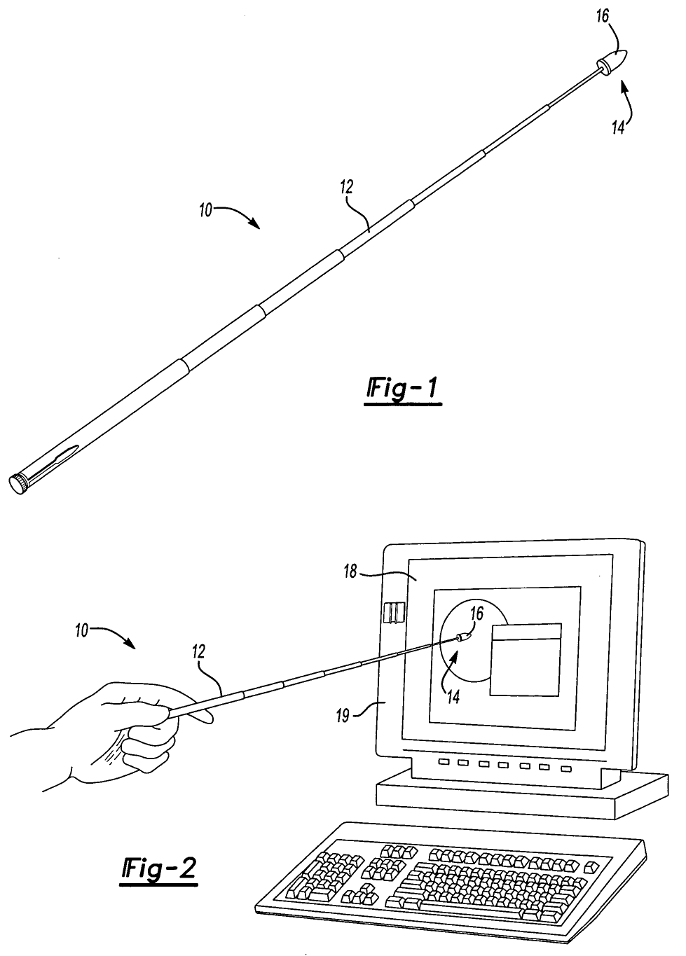

Referring to FIG. 1, an inventive pointer assembly is generally shown at 10. The assembly includes an expandable member 12 having a distal end 14. A tip 16 encloses the distal end 14 of the expandable member 12. The tip includes a durometer hardness that is selected to prevent scratching and marring of a monitor 18, such as, for example, a plasma computer screen generally shown in FIG. 2.

In increasing frequency, presentation material is presented on monitors as opposed to on paper products, it has become necessary to identify particular pixels or areas of the image generated on the monitor during working meetings or other similar work functions. As represented in FIG. 2, the inventive pointer assembly 10 is adapted to identify pixels and specific areas on the monitor 18 contacting the screen of the monitor 18 while not scratching or marring the screen.

The preferred tip 16 formulation has proven to prevent scratching and marring of a computer screen 18 through a series of studies. Preferably, the tip 16 is formed from an elastomer having a durometer hardness of greater than generally 85 shore A hardness. Elastomer tips having a durometer hardness less than generally 85 shore A hardness have been shown to mar monitors 18, and more specifically, mar plasma or LCD monitor screens. More preferably, the inventive tip 16 is formed from a thermo-plastic polyolefin elastomer or an equivalent elastomer having a generally similar material composition able to generate a generally similar durometer hardness. Various alternate embodiments of the tip 16 design are disclosed further below.

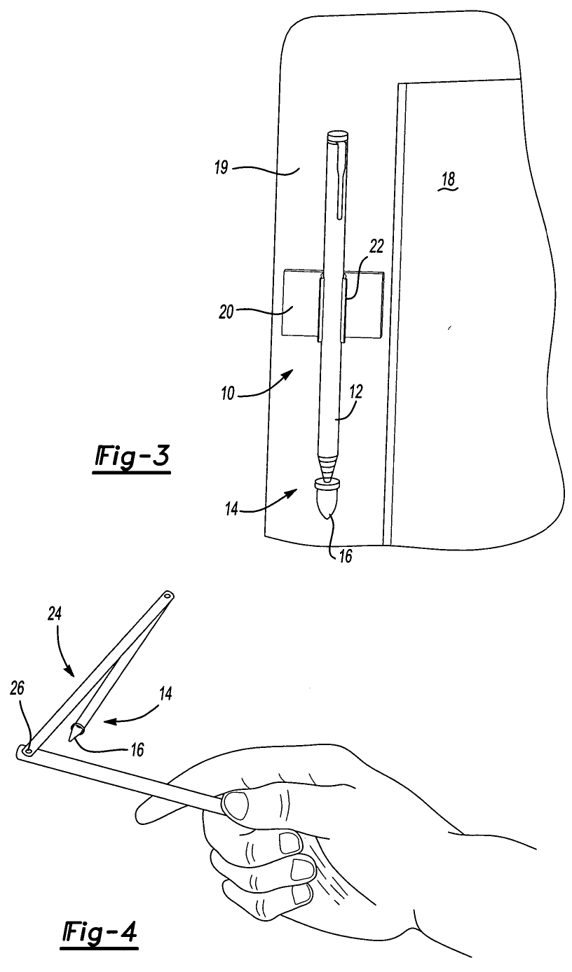

FIG. 3 shows the inventive assembly 10 releasably affixed to the computer monitor 19 by a clip 20 adapted to receive the expandable member 12 of the assembly 10 when the expandable member 12 is disposed in a retracted state. The clip 20 is affixable to the monitor 19 with an adhesive and includes a spring member 22 configured to releasably clasp the expandable member 12 of the assembly 10.

Preferably, the expandable member 12 of the assembly 10 comprises a telescoping rod as is best representative in FIGS. 1 and 2. However, alternative expandable members 24 having pivot points 26 provide an assembly 10 where the length is adjusted through a folding process as shown in FIG. 4.

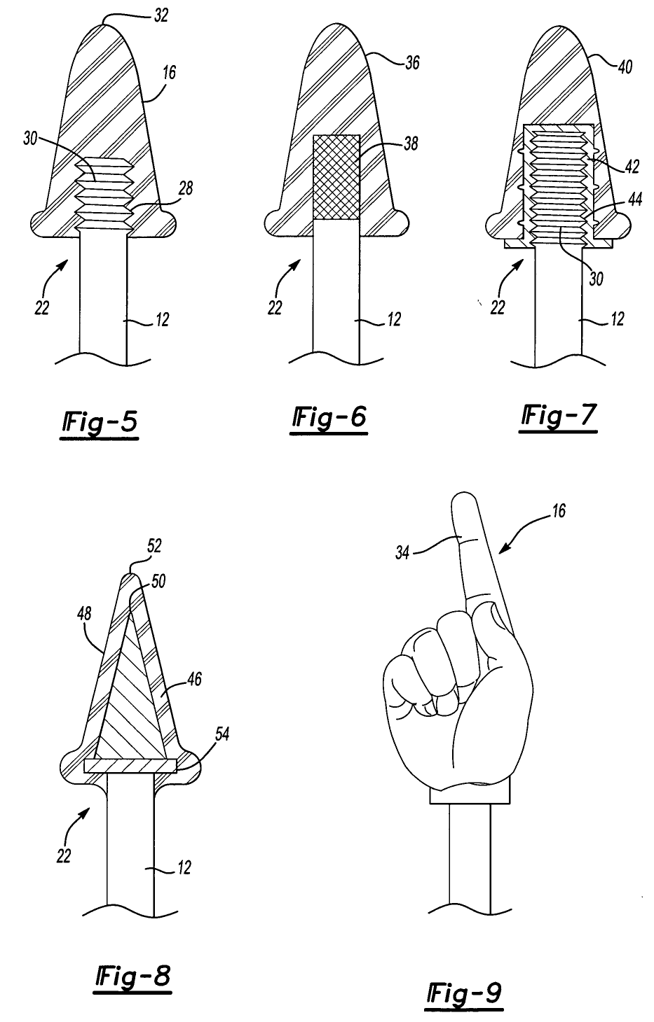

Referring now to FIG. 5, a preferred embodiment provides a tip 16 that is molded to enclose a distal end 22 of the expandable member 12. The tip 16 is injection molded onto the distal end 22 of the expandable member 12. Alternatively, the tip 16 is injection molded separately and defines a threaded interior surface 28 adapted to receive helical threads 30 disposed upon the distal end 22 of the expandable member 12. In this embodiment, the tip 16 is releasably retained by the helical threads disposed upon the distal end 22 of the expandable member 12 allowing for the tip 16 to be replaced when desired. Furthermore, the tip 16 is contoured to define a tapered configuration terminating at an apex 32. However, other shaped tips may be produced as is represented in FIG. 9 where the tip 16 takes the form of a human appendage 34, in this embodiment, a human hand with an extended index finger.

Referring now to FIG. 6, an alternate tip 36 is shown where an interference fit retains the tip 36 to the expandable member 12. The distal end 22 preferably includes a scored surface 38 providing frictional forces to retain the tip 36 upon the expandable member 12. The tip 36 is injection molded onto the distal end 22 of the expandable member 12, or alternatively is pressed onto the expandable member 12 and merely retained by the interference fit described above.

Referring now to FIG. 7, a still further alternate tip 40 is shown where an insert 42 is secured within the alternate tip 40 and defines a threaded inner surface 44 adapted to receive the helical threads 30 disposed upon the distal end 22 of the expandable member 12. Preferably, the insert 42 is formed from a material having a durometer hardness greater than that of the tip 40 so that the tip 40 may be repeatedly removed from the expandable member 12 without deteriorating a threaded surface that is disposed within the tip 40 itself. The insert 42 may even be formed from a metallic material allowing for frequent tip 40 removal and replacement. Further, it is preferable to injection mold the tip 40 onto the insert 42 when producing the tip 40.

A still further embodiment is shown in FIG. 8 where an elastomer coating 46 is disposed upon the distal end 22 of the expandable member 12. The preferred elastomer coating 46 provides the desirable durometer set forth above and is produced by Rhodes American of Palatine, Ill. A single layer of elastomer coating 46 or multiple layers may be used as desired. The distal end 22 is preferably machined to produce the desired contour to the alternate tip 48 having an apex 50 that translates through the elastomer coating 46 to provide an elastomer apex 52 having a desired durometer hardness. A nut 54 is alternatively threaded onto the distal end 22 of the expandable member 12 to provide desired contours to the alternate tip 48. The distal end 22 of the expandable member 12 defines various configurations that translate through the elastomer coating 46 to provide the desired shaped tip 48.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A pointer assembly for identifying locations on a monitor, comprising:
an expandable member having a distal end, wherein said distal end is enclosed by a tip having a durometer hardness selected to prevent scratching and marring of the monitor.

2. An assembly as set forth in claim 1, wherein said expandable member comprises a telescoping rod.

3. An assembly as set forth in claim 1, wherein said tip comprises an elastomer.

4. An assembly as set forth in claim 3, wherein said elastomer includes a durometer greater than generally 85 shore A hardness.

5. An assembly as set forth in claim 3, wherein said elastomer comprises a thermoplastic polyolefin elastomer.

6. An assembly as set forth in claim 1, wherein said tip is injection molded onto said distal end.

7. An assembly as set forth in claim 1, wherein said tip is coated over said distal end.

8. An assembly as set forth in claim 7, wherein said distal end is contoured thereby providing a tapered configuration to said tip that is coated.

9. An assembly as set forth in claim 1, wherein said tip is contoured thereby defining a tapered configuration.

10. An assembly as set forth in claim 1, wherein said tip is shaped as an appendage of a human body.

11. An assembly as set forth in claim 1, wherein said distal end comprises a helical thread and said tip is adapted to receive said helical thread thereby releasably retaining said tip to said distal end.

12. An assembly as set forth in claim 10, wherein said tip comprises an insert having a durometer hardness greater than a said durometer hardness of said tip and being adapted to receive said helical thread thereby releasably retaining said tip to said distal end.

13. An assembly as set forth in claim 12, wherein said distal end is scored thereby providing a surface having a friction coefficient capable of retaining said tip on said distal end.

14. A pointer assembly for identifying a location on a monitor, comprising an elongated member having a distal end with a tip covered by an elastomer defining an apex adapted to contact the monitor at desired locations on the monitor, wherein said elastomer includes a durometer hardness selected to prevent scratching and marring the monitor.

15. A pointer assembly as set forth in claim 14, wherein said elongated member is expandable between at least a first and a second length.

16. A pointer assembly as set forth in claim 15, wherein elastomer includes a durometer hardness of at least generally 85 shore A hardness.

17. A pointer assembly as set forth in claim 14, wherein said elastomer comprises a thermoplastic polyolefin.

18. A pointer assembly as set forth in claim 14, wherein said distal end of said elongated member defines a scored surface thereby retaining said tip on said distal end.

19. A pointer assembly as set forth in claim 14, wherein said distal end of said elongated member defines a threaded surface to threadably receive said tip.

20. A pointer assembly as set forth in claim 19, wherein said tip includes an insert defining a threaded surface for threadably engaging said threaded surface of said distal end.

21. A pointer assembly as set forth in claim 14, further including a receptor affixable to the monitor and adapted to releasably receive said elongated member.
